(19) United States
(12) Patent Application Publication
(10) Pub. No.: US 2013/0074042 A1
(43) Pub. Date: Mar. 21, 2013

(54) VISUALIZING THREAD STATE DURING PROGRAM DEBUGGING

(71) Applicants: George Essex Engelbeck, Issaquah, WA (US); Vikram Bapat, Seattle, WA (US); Puneet Sharma, Hyattsville, MD (US)

(72) Inventors: George Essex Engelbeck, Issaquah, WA (US); Vikram Bapat, Seattle, WA (US); Puneet Sharma, Hyattsville, MD (US)

(73) Assignee: Microsoft Corporation, Redmond, WA (US)

(21) Appl. No.: 13/329,733

(22) Filed: Dec. 19, 2011

Related U.S. Application Data
(60) Provisional application No. 61/536,474, filed on Sep. 19, 2011.

(51) Int. Cl. G06F 9/44

(52) U.S. Cl. 717/125

(57) ABSTRACT

The present invention extends to methods, systems, and computer program products for visualizing thread state during program debugging. A tooltip can present a visual summary of the execution state of the application threads, what the values are, and patterns in the values, during debugging. As such, a developer debugging a parallel application can see the status of threads within a thread block. A visual tooltip (or other presentation mechanism) can be activated by hovering (e.g., placing a mouse pointer) over a user interface element. A visual tooltip can be presented by hovering over a status rollup visualization of the thread states or by hovering over an icon that appears in the code gutter for a code segment. Accordingly, developers can get a concise visual summary of thread states, variables, and values during debugging.

### CROSS-REFERENCE TO RELATED APPLICATIONS

The present application claims the benefit of U.S. Provisional Patent Application Ser. No. 61/536,474, entitled “VISUALIZING THREAD STATE DURING PROGRAM DEBUGGING”, filed Sep. 19, 2011, which is incorporated by reference herein in its entirety.

### BACKGROUND

1. Background and Relevant Art

Computer systems and related technology affect many aspects of society. Indeed, the computer system's ability to process information has transformed the way we live and work. Computer systems now commonly perform a host of tasks (e.g., word processing, scheduling, accounting, etc.) that prior to the advent of the computer system were performed manually. More recently, computer systems have been coupled to one another and to other electronic devices to form both wired and wireless computer networks over which the computer systems and other electronic devices can transfer electronic data. Accordingly, the performance of many computing tasks are distributed across a number of different computer systems and/or a number of different computing environments.

In many computing environments, applications execute in a multi-threaded or parallel manner, where portions of work for the application are executed on different threads or processes. To appropriately debug multi-threaded applications or parallel applications, developers need to know the state of the application's running threads or processes. For many applications there can be thousands of threads. As the number of threads increases, the process of sifting through tables and lists of values corresponding becomes more time consuming and error prone.

Some debugging mechanisms show developers a list of identifiers, state descriptions, and variables in a textual form. However, to locate the appropriate debugging information, developers are required to scroll through these lists scanning for anomalous values.

### BRIEF SUMMARY

The present invention extends to methods, systems, and computer program products for visualizing thread state during program debugging. A computer system includes a debugger configured for debugging multi-threaded applications. A visual representation of thread state for a multi-threaded application is provided at a display device.

A multi-threaded application is executed. The multi-threaded application performs work on a plurality of different threads. The debugger is attached to the multi-threaded application. A thread state user-interface element is presented at the display device. The thread state user-interface element indicates that a thread state visualization is available for the plurality of different threads. The thread state visualization is for visually representing the state of each of the plurality of different threads relative to one another. Accordingly, an overall program view of the multi-threaded application can be visually presented.

Input selecting the thread state user-interface element is received. The thread state visualization is visually presented on the display device in response to the received input. The thread state visualization provides the overall program view of the multi-threaded application at the display device.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an example computer architecture that facilitates visualizing thread state during program debugging.

FIG. 2 illustrates a flow chart of an example method for visualizing thread state during program debugging.

FIG. 3 illustrates an example user-interface screen for visualizing the state of an application.

FIG. 4 illustrates an example user-interface screen for visualizing the execution location of threads within a segment of code.

FIG. 5 illustrates an example user-interface screen for visualizing the state of an application within a segment of code.

### DETAILED DESCRIPTION

The present invention extends to methods, systems, and computer program products for visualizing thread state during program debugging. A computer system includes a debugger configured for debugging multi-threaded applications. A visual representation of thread state for a multi-threaded application is provided at a display device.

A multi-threaded application is executed. The multi-threaded application performs work on a plurality of different threads. The debugger is attached to the multi-threaded application. A thread state user-interface element is presented at the display device. The thread state user-interface element indicates that a thread state visualization is available for the plurality of different threads. The thread state visualization is for visually representing the state of each of the plurality of different threads relative to one another. Accordingly, an overall program view of the multi-threaded application can be visually presented.

Input selecting the thread state user-interface element is received. The thread state visualization is visually presented on the display device in response to the received input. The thread state visualization provides the overall program view of the multi-threaded application at the display device.

Embodiments of the present invention may comprise or utilize a special purpose or general-purpose computer including computer hardware, such as, for example, one or more processors, system memory, and a display device, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, embodiments of the invention can comprise at least two distinctly different kinds of computer-readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that computer storage media (devices) can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the invention facilitate visualizing the state of threads during debugging of an application. For example, a tooltip can present a visual summary of the execution state of the application threads, what the values are, and patterns in the values, during debugging. As such, a developer debugging a parallel application can see the status of threads within a thread block. A visual tooltip (or other presentation mechanism) can be activated by hovering (e.g., placing a mouse pointer) over a user interface element. For example, a visual tooltip can be presented by hovering over a status rollup visualization of the thread states within a thread block. Likewise, a visual tooltip can be presented by hovering over an icon that appears in the code gutter for a code segment. Accordingly, developers can get a concise visual summary of thread states, variables, and values during debugging.

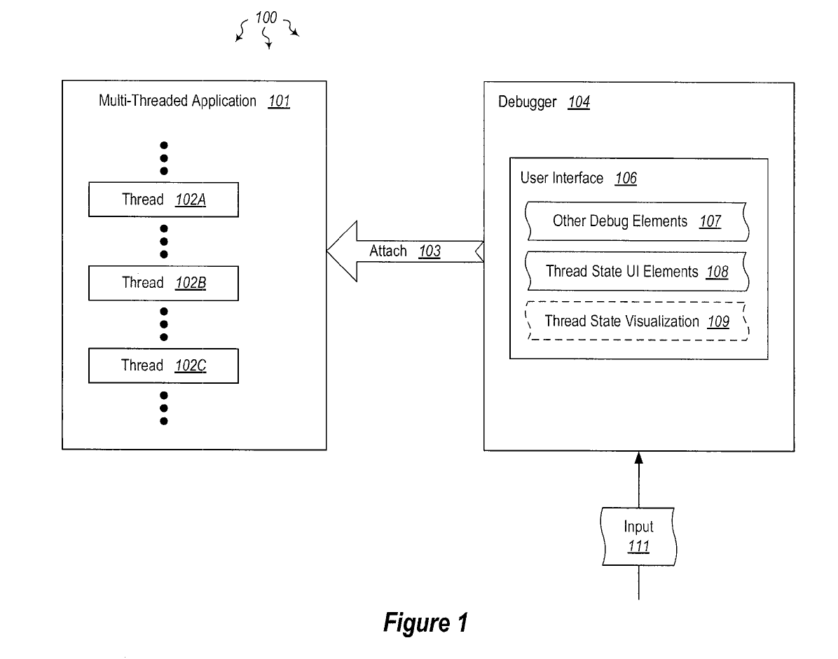

FIG. 1 illustrates an example computer architecture 100 that facilitates visualizing thread state during program debugging. Referring to FIG. 1, computer architecture 100 includes multi-threaded application 101 and debugger 104. Each of multi-threaded application 101 and debugger 104 can be connected to one another over (or be part of) a network, such as, for example, a Local Area Network (“LAN”), a Wide Area Network (“WAN”), and even the Internet. Accordingly, each of multi-threaded application 101 and debugger 104 as well as any other connected computer systems and their components, can create message related data and exchange message related data (e.g., Internet Protocol (“IP”) datagrams and other higher layer protocols that utilize IP datagrams, such as, Transmission Control Protocol (“TCP”), Hypertext Transfer Protocol (“HTTP”), Simple Mail Transfer Protocol (“SMTP”), etc.) over the network.

In general, a multi-threaded application can perform work across hundreds or even thousands of different threads. For example, multi-threaded application 101 can perform work across a plurality of different threads including threads 102A, 102B, and 102C. The vertical ellipsis before, between, and after threads 102A, 102B, and 102C represent that multi-threaded application 100 can include any number of other additional threads.

In general, a debugger can be used to test and debug other programs (a target program). A debugger can offer functions such as, for example, single stepping, breaking, value tracking, jumping, state modification, etc. For example, debugger 104 can be a debugger configured to debug multi-threaded applications. Debugger 104 can provide user-interface 106 that presents user-interface elements for the various debugging functions of debugger 104. User-interface elements can include a thread state user-interface element. When selected, a thread state user-interface element can present a thread state user-interface. The thread state user-interface visually indicates the state of a plurality of threads from a multi-threaded application.

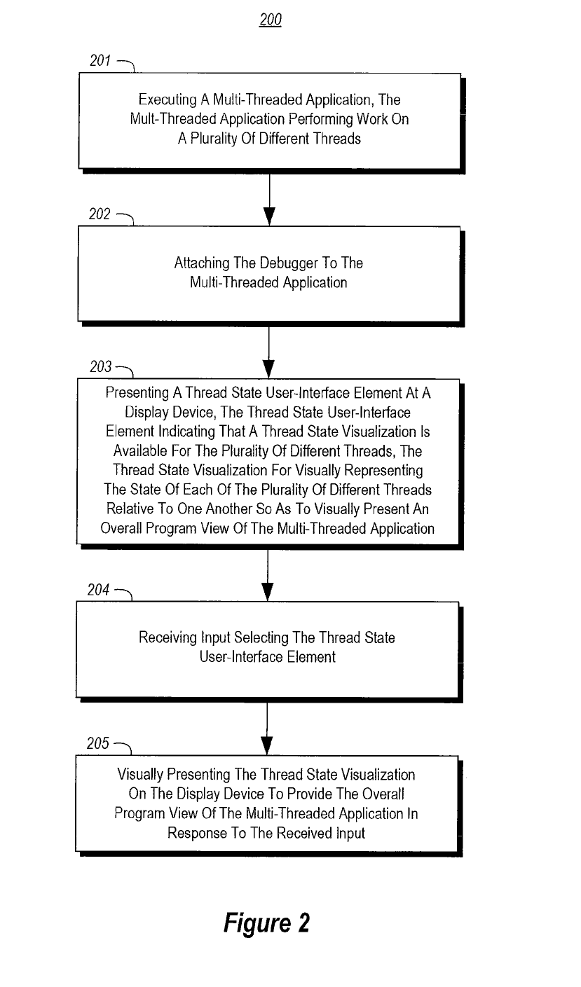

FIG. 2 illustrates a flow chart of an example method 200 for visualizing thread state during program debugging. Method 200 will be described with respect to the components and data of computer architecture 100.

Method 200 includes an act of executing a multi-threaded application, the multi-threaded application performing work on a plurality of different threads (act 201). For example, multi-threaded application 101 can be executed at a computer system. Multi-threaded application 101 performs work across a plurality of different threads including (but not necessarily limited to) threads 102A, 102B, and 102C. Method 200 includes an act of attaching the debugger to the multi-threaded application (act 202). For example, debugger 104 can be attached 102 to multi-threaded application 101.

Method 200 includes an act of presenting a thread state user-interface element at a display device, the thread state user-interface element indicating that a thread state visualization is available for the plurality of different threads, the thread state visualization for visually representing the state of each of the plurality of different threads relative to one another to visually present an overall program view of the multi-threaded application (act 203). For example, user-interface 106 can present thread state UI element 108 (e.g., a user-interface control) at a display device. Thread state UI element 108 can indicate that a thread state visualization is available for at least a group of threads of multi-threaded application 101, such as, for example, a group of threads including threads 102A, 102B, 102C. The thread state visualization can visually present the state of the threads in the at least a group of threads relative to one another. The visual presentation of the state of threads relative to one another can provide an overall program view of the multi-threaded application.

User interface 106 can also present other debug elements 107 representing other debugging functionality of debugger 104.

Method 200 includes an act of receiving input selecting the thread state user-interface element (act 204). For example, debugger 104 can receive (e.g., user) input 111 selecting thread state UI element 108. Method 200 includes an act of visually presenting the thread state visualization on the display device to provide the overall program view of the multi-threaded application in response to the received input (act 205). For example, debugger 104 can present thread state visualization 109 at the display device in response to input 111. Thread state visualization 109 can provide an overall program view of multi-threaded application 101. When presented on a display device, thread state visualization can be presented along with and/or partially cover other user-interface elements of user-interface 106.

In general, a thread state UI element can be presented in different portions of user-interface 106 to provide a mechanism to visualize different characteristics of thread state. For example, a thread state UI element can be included in a status rollup for a thread group, within the code gutter when presenting source code instructions, etc.

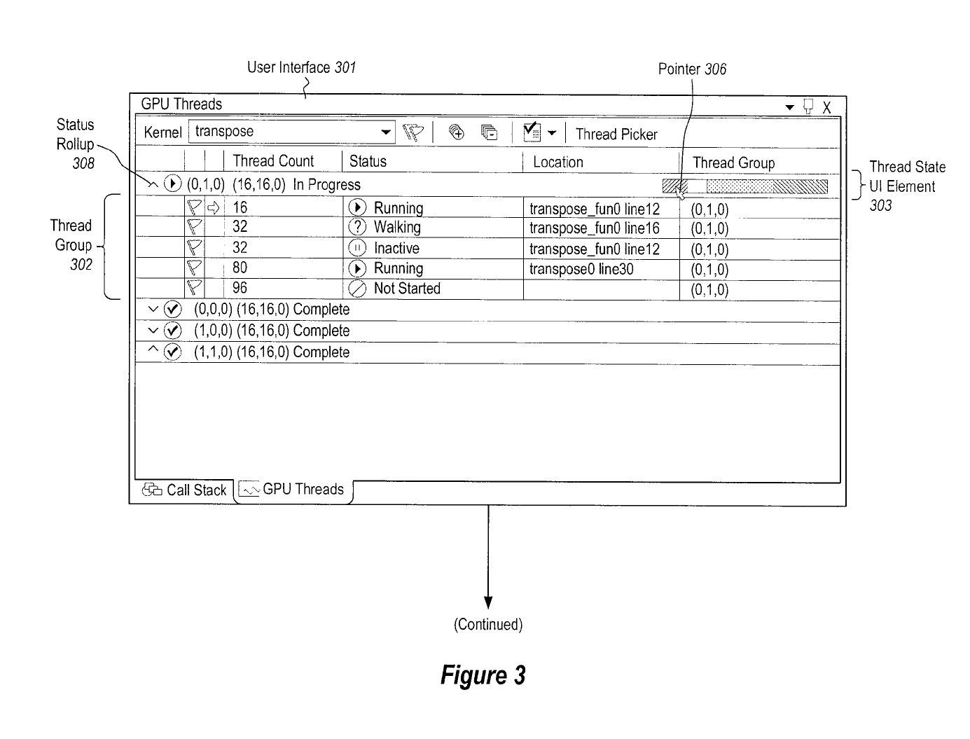

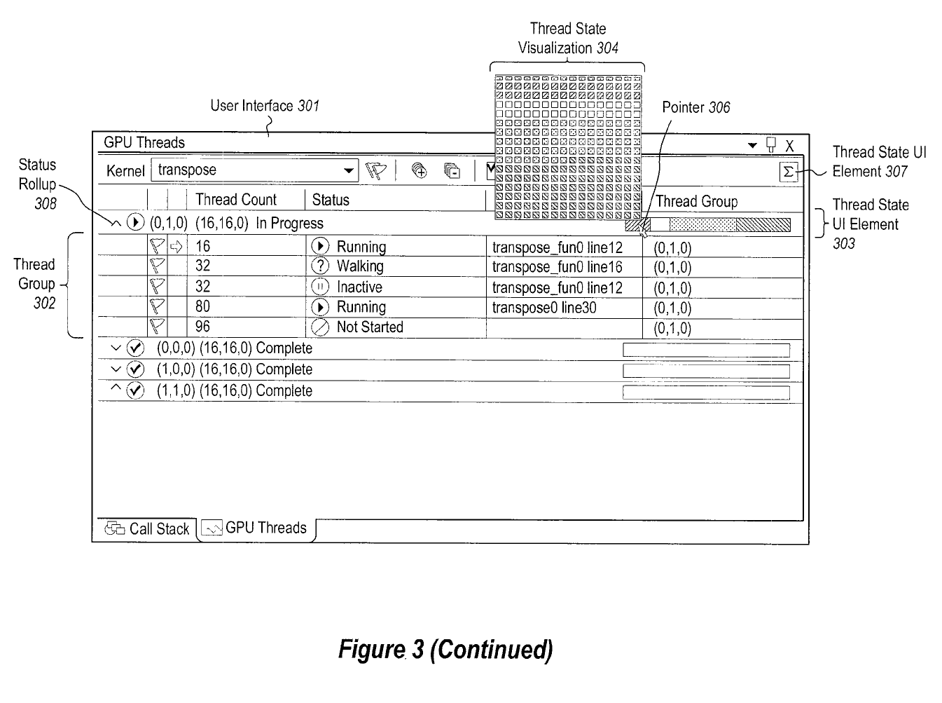

FIG. 3 illustrates an example user-interface screen 301 for visualizing the state of an application. User-interface screen 301 can be presented within a debugger to visually indicate information about thread groups at a display device. As depicted, user-interface 301 presents data for a number of thread groups including thread group 302. Thread group 302 includes 256 threads, different portions of thread group 302 are in different states, including running, waiting, inactive, and not-started. Thread state UI element 303 visually depicts a summary of thread states for threads in thread group 302.

Pointer 306 (e.g., a mouse pointer) can be positioned over thread state UI element 303. When pointer 306 is positioned over thread state UI element 303, thread state visualization 304 can be presented at user-interface screen 301. Thread state visualization 304 depicts the state of threads in thread group 302 relative to one another.

Thread state UI element 307 (“s”) can be selected to present a thread state visualization for threads in all thread groups relative to one another.

User-interface screen 301 can be presented to a user (e.g., a developer) that is debugging Graphical Processing Unit (“GPU”) code. The GPU code can include a plurality of threads, including the 256 threads of thread group 302. The user can move pointer 306 to hover over status rollup 308 (i.e., {0,1,0}, a status rollup for thread group 302) to get more information about the thread group state for thread group 302. Thread state visualization 304 shows the user the state of the threads within thread group 302 using color coding (e.g., green=running, yellow=waiting, white=inactive, red=non started).

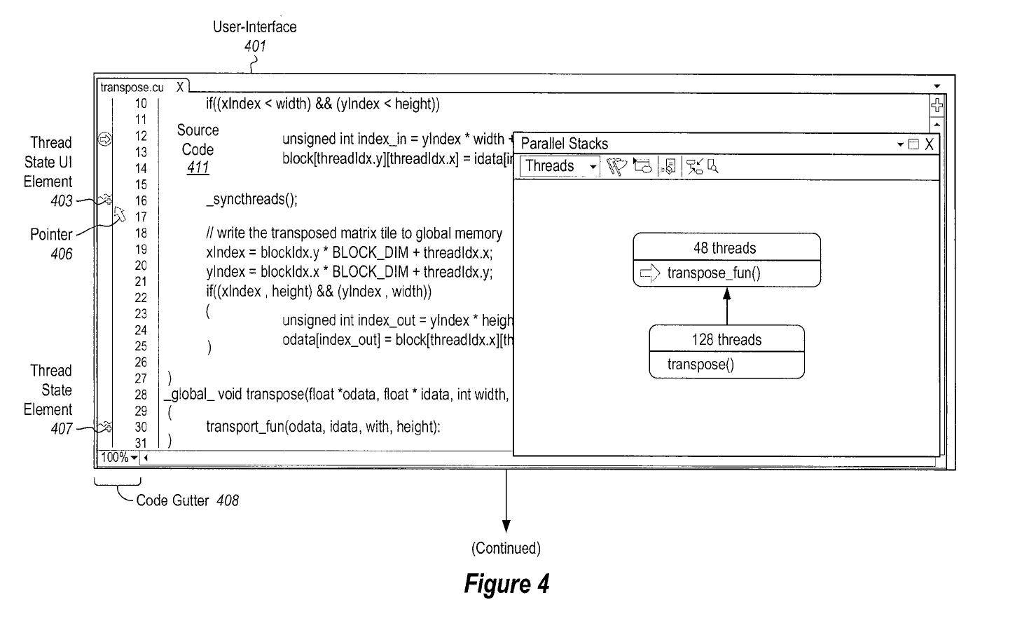

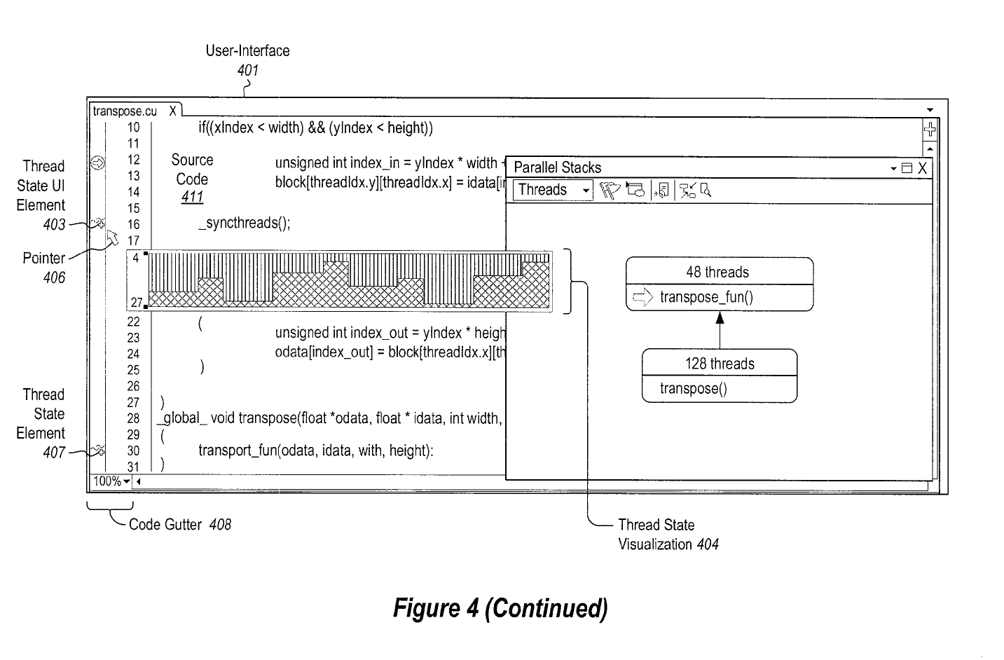

FIG. 4 illustrates an example user-interface screen 401 for visualizing the execution location of threads within a segment of code. User-interface screen 401 can be presented within a debugger to visually indicate information about thread groups at a display device. As depicted, user-interface screen 401 presents source code 411 and corresponding line numbers. The depicted source code 411 can be GPU code which has 256 threads.

Pointer 406 (e.g., a mouse pointer) can be positioned over thread state UI element 403. When pointer 406 is positioned over thread state UI element in code gutter 408 (e.g., a cloth thread icon representing thread state UI element 403 or 407), a corresponding thread state visualization can be presented at user interface 401. The thread state visualization depicts the state of threads during execution between various lines of source code 411, such as, for example, within a specified method.

User interface 401 can be presented to a user (e.g., developer) that is debugger Graphical Processing Unit (“GPU”) source code 411. The developer can move pointer 406 to hover over thread state UI element 403. Thread state UI element 403 can indicate that there are multiple threads executing this line of code. Thread state visualization 404 provides a summary of the execution of threads (i.e., progress) against line numbers for the source code 411 (4 . . . 27) associated with the location where pointer 406 is hovering. Threads can also be grouped by thread block. Accordingly, a user is provided with a visualization of thread state relative to locations in source code 411.

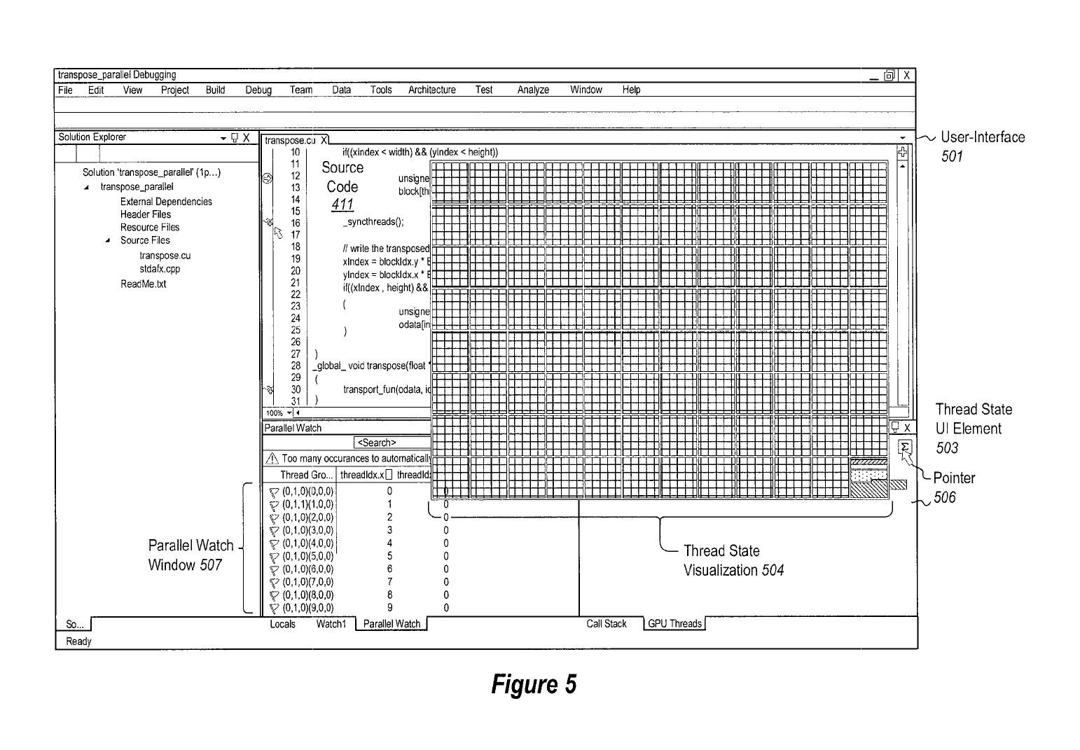

FIG. 5 illustrates an example user-interface screen 501 for visualizing the state of an application within a segment of code. User-interface screen 501 can be presented within a debugger to visually indicate information about thread groups at a display device. As depicted, user-interface screen 501 presents source code 411 and corresponding line numbers along with parallel watch window 507 for thread groups. Across all thread groups there can be a total of 24,576 threads. The 24,576 threads can be divided into 96 thread groups. Each thread group can have 256 (16×16) threads. Different threads can have different states including running, waiting, inactive, and not-started.

Pointer 506 (e.g., a mouse pointer) can be positioned over thread state UI element 503 (Σ). When pointer 506 is positioned over thread state UI element 503, thread state visualization 504 can be presented at user interface 501. Thread state visualization 504 depicts the state of the 24,576 threads (grouped by thread block) used during execution relative to one another. Thread state visualization 504 shows the developer the state of the 24,576 threads by color coding (e.g., green=running, yellow=waiting, white=inactive, red=non started, blue=unused). Accordingly, a user (e.g., developer) can see the state of all threads within a program relative to locations within source code 411.

Accordingly, embodiments of the invention can provide a visualization of threads and variables within a location specific datatip. Datatips are interactive enabling a user (developer) to switch between threads, drill into a thread or variable for more details, and navigate to a location within a code file. A summary visualization rolls up a summary of thread states.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed:

1. At a computer system including one or more processors, system memory, and a display device, the computer system also including a debugger, the debugger configured for debugging multi-threaded applications, a method for providing a visual representation of thread state for a multi-threaded application, the method comprising:
an act of executing a multi-threaded application, the multi-threaded application performing work on a plurality of different threads;
an act of attaching the debugger to the multi-threaded application;
an act of presenting a thread state user-interface element at the display device, the thread state user-interface element indicating that a thread state visualization is available for the plurality of different threads, the thread state visualization for visually representing the state of each of the plurality of different threads relative to one another so as to visually present an overall program view of the multi-threaded application;
an act of receiving input selecting the thread state user-interface element; and
an act of visually presenting the thread state visualization on the display device to provide the overall program view of the multi-threaded application in response to the received input.

2. The method as recited in claim 1, wherein an act of presenting a thread status user-interface element at the display device comprises an act of presenting a user-interface element that depicts a summary of the overall program view.

3. The method as recited in claim 1, wherein an act of presenting a thread status user-interface element at the display device comprises an act of presenting the thread status user-interface element in a status rollup for thread groups.

4. The method as recited in claim 1, wherein an act of presenting a thread status user-interface element at the display device comprises an act of presenting the thread status user-interface element that can be selected to simultaneously visualize thread state for a plurality of threads of a multi-threaded application.

5. The method as recited in claim 1, wherein an act of presenting a thread status user-interface element at the display device comprises an act of presenting the thread status user-interface element in a code gutter.

6. The method as recited in claim 1, wherein the act of visually presenting the thread status visualization on the display device comprises an act of presenting a graphical element for each of the plurality of threads, the graphical element indicating the status of a thread, the status selected from among: running, waiting, inactive, and not started.

7. The method as recited in claim 1, wherein the act of visually presenting the thread status visualization on the display device comprises an act of presenting a color coded graphical element for each of the plurality of threads, the color coding indicating execution state relative to line numbers within source code that was compiled into the multi-threaded application.

8. The method as recited in claim 1, wherein the act of visually presenting the thread state visualization on the display device comprises an act of visually presenting a thread state visualization for a specified location within source code that was compiled into the multi-threaded application.

9. A computer program product for use at a computer system including a display device, the computer system also including a debugger, the debugger configured for debugging multi-threaded applications, the computer program product for implementing a method for providing a visual representation of thread state for a multi-threaded application, the computer program product comprising one or more computer storage media having stored thereon computer-executable instructions that, when executed at a processor, cause the computer system to perform the method, including the following:
execute a multi-threaded application, the multi-threaded application performing work on a plurality of different threads;
attach the debugger to the multi-threaded application;
present a thread state user-interface element at the display device, the thread state user-interface element indicating that a thread state visualization is available for the plurality of different threads, the thread state visualization for visually representing the state of each of the plurality of different threads relative to one another so as to visually present an overall program view of the multi-threaded application;
receive input selecting the thread state user-interface element; and
visually present the thread state visualization on the display device to provide the overall program view of the multi-threaded application in response to the received input.

10. The computer program product as recited in claim 9, wherein computer-executable instructions that, when executed, cause the computer system to present a thread state user-interface element at the display device comprise computer-executable instructions that, when executed, cause the computer system to present a user-interface element that depicts a summary of the overall program view.

11. The computer program product as recited in claim 9, wherein computer-executable instructions that, when executed, cause the computer system to present a thread state user-interface element at the display device comprise computer-executable instructions that, when executed, cause the computer system to present the thread status user-interface element in a status rollup for thread groups.

12. The computer program product as recited in claim 9, wherein computer-executable instructions that, when executed, cause the computer system to present a thread state user-interface element at the display device comprise computer-executable instructions that, when executed, cause the computer system to present the thread status user-interface element that can be selected to visualize thread state for all threads multi-threaded applications simultaneously.

13. The computer program product as recited in claim 9, wherein computer-executable instructions that, when executed, cause the computer system to present a thread state user-interface element at the display device comprise computer-executable instructions that, when executed, cause the computer system to present the thread status user-interface element in a code gutter.

14. The computer program product as recited in claim 9, wherein computer-executable instructions that, when executed, cause the computer system to visually present the thread state visualization on the display device comprise computer-executable instructions that, when executed, cause the computer system to present a color coded graphical element for each of the plurality of threads, the color coding indicating the status of a thread, the status selected from among: running, waiting, inactive, and not started.

15. The computer program product as recited in claim 9, wherein computer-executable instructions that, when executed, cause the computer system to visually present the thread state visualization on the display device comprise computer-executable instructions that, when executed, cause the computer system to present a color coded graphical element for each of the plurality of threads, the color coding indicating execution state relative to line numbers within source code that was compiled into the multi-threaded application.

16. The computer program product as recited in claim 9, wherein computer-executable instructions that, when executed, cause the computer system to visually present the thread state visualization on the display device comprise computer-executable instructions that, when executed, cause the computer system to visually present a thread state visualization for a specified location within source code that was compiled into the multi-threaded application.

17. A computer system, the computer system comprising:
one or more processors;
system memory;
a display device; and
one or more computer storage devices having stored thereon computer executable instructions representing a debugger, wherein the debugger is configured to:
attach to an executing multi-threaded application, the multi-threaded application including a plurality of different threads, the plurality of different threads grouped into thread blocks;
present a thread state user-interface element within an user-interface at the display device, the thread state user-interface element indicating that a thread state visualization is available for the plurality of different threads, the thread state visualization for visually representing the state of each of the plurality of different threads relative to one another so as to visually present an overall program view of the multi-threaded application relative to a location within corresponding source code;
receive input selecting the thread state user-interface element; and
visually present the thread state visualization on the display device to provide the overall program view of the multi-threaded application in response to the received input, the thread state visualization indicating the status of each of the plurality of different threads, the status selected from among: running, waiting, inactive, and not started.

18. The computer system as recited in claim 17, wherein the debugger being configured to present a thread state user-interface element within a user-interface at the display device comprises the debugger being configured to present the thread status user-interface element in a status rollup for thread groups.

19. The computer system as recited in claim 17, wherein the debugger being configured to present a thread state user-interface element within a user-interface at the display device comprises the debugger being configured to present the thread status user-interface element in a code gutter.

20. The computer system as recited in claim 17, wherein the debugger being configured to present a thread state user-interface element within a user-interface at the display device comprises the debugger being configured to present the thread status user-interface element in a user-interface screen that also includes a listing of source code and a parallel watch window.
